(19) United States
(12) Patent Application Publication
(10) Pub. No.: US 2026/0210797 A1
(43) Pub. Date: Jul. 23, 2026

(54) HIGH-LOW TEMPERATURE AND HIGH-FREQUENCY ANGULAR VIBRATION DEVICE BASED ON HYDROSTATIC BEARING SYSTEM

(71) Applicant: BEIJING AEROSPACE INSTITUTE FOR METROLOGY AND MEASUREMENT TECHNOLOGY, Beijing (CN)

(72) Inventors: Yinxiao MIAO, Beijing (CN); Chunxi WANG, Beijing (CN); Hongzheng ZHANG, Beijing (CN); Shuo YANG, Beijing (CN); Mingrong TIAN, Beijing (CN); Yingmin ZHOU, Beijing (CN); Junxiu ZHANG, Beijing (CN); Nannan ZHAO, Beijing (CN); Shujun LIU, Beijing (CN); Xubo LI, Beijing (CN)

(21) Appl. No.: 19/566,583

(22) Filed: Mar. 13, 2026

(30) Foreign Application Priority Data
Mar. 14, 2025 (CN) 202510306287.9

(51) Int. Cl. G01M 7/04; F16C 32/06; G01N 17/00

(52) U.S. Cl. CPC G01M 7/045; F16C 32/0651; G01N 17/002; F16C 2370/00

(57) ABSTRACT

A high-low temperature and high-frequency angular vibration device includes an angular vibration table assembly, a temperature-controllable chamber and a control system. The angular vibration table assembly includes a base, a hydrostatic bearing, a torque motor, an adapter assembly, an encoder, a conductive slip ring, a thermal-insulating shaft and a worktable. The hydrostatic bearing includes a bearing seat, an upper bearing sleeve, a hydrostatic shaft and a lower bearing sleeve. The torque motor includes a stator and a rotor, and is internally provided with a motor shaft. The adapter assembly includes an adapter flange and a transmission key. The thermal-insulating shaft includes an upper shaft section, a middle shaft section and a lower section. The control system is configured to control a temperature of the temperature-controllable chamber, and an angular frequency, an angular rate and an angular position of the angular vibration table assembly.

### CROSS-REFERENCE TO RELATED APPLICATIONS

This application claims the benefit of priority from Chinese Patent Application No. 202510306287.9, filed on March 14, 2025. The content of the aforementioned application, including any intervening amendments thereto, is incorporated herein by reference in its entirety.

### TECHNICAL FIELD

This application relates to testing apparatuses for inertial devices, and more particularly to a high-low temperature and high-frequency angular vibration device based on a hydrostatic bearing system.

### BACKGROUND

For missile weapons, improvement of survivability ranks as a key research priority, as well as enhancement of strike accuracy. As critical components for detecting the attitude variations of missile weapons, inertial devices can provide an autonomous navigation capability for missiles to boost strike accuracy. Meanwhile, rapid launch is one of the critical approaches to improve missile survivability. Preheating of inertial navigation system is a vital preparation for pre-launch. If the performance parameters of inertial devices under different temperature conditions are calibrated in advance, warm-up time of the inertial navigation system will be greatly shortened to enable rapid launch.

For the inertial devices, parameter calibration is performed in advance in high and low temperature environments, which can facilitate rapid launch. In the existing technologies, high-low temperature calibration systems for the inertial devices have satisfied the calibration requirements of angular position and angular velocity in high and low temperature environments. However, in terms of high-frequency angular vibration parameter calibration, high-low temperature conditions and high-frequency angular vibration are still performed separately, which fails to accurately reproduce angular vibration characteristics in high and low temperature environments. Therefore, under high and low temperature conditions, high-frequency angular vibration calibration method is studied to effectively improve the navigation accuracy of the inertial navigation system under high-frequency angular vibration and high-low temperature variations, and to provide technical support for shortening the warm-time time.

Metrological calibration of the inertial devices under high and low temperature conditions, coupled with pre-calibration of compensation parameters corresponding to various temperatures, enables a remarkable improvement in the environmental adaptability of the inertial navigation system under such temperature conditions, thereby enhancing the rapid launch capability of missiles. This research direction will not only contribute to higher strike accuracy of missile weapons, but also further enhance their survivability, thereby providing critical support for combat deployment of missile weapons.

At present, a large number of devices capable of high angular rate, high acceleration and low-frequency angular vibration under high and low temperature conditions have been developed commercially. The parameters for low-frequency angular vibration are generally tens of hertz. However, the development of high-frequency angular vibration devices under high and low temperature conditions has not been addressed, resulting in the inability of existing equipment to meet relevant testing requirements. Therefore, it is of great practical significance to develop a device that can offer high-frequency angular vibration in high and low temperature environments.

### SUMMARY

In view of this, the present disclosure provides a high-low temperature and high-frequency angular vibration device based on a hydrostatic bearing system, so as to enable high-frequency angular vibration in high and low temperature environments.

The present disclosure adopts the following technical solutions.

A high-low temperature and high-frequency angular vibration device based on a hydrostatic bearing system, comprising:

an angular vibration table assembly;

a temperature-controllable chamber; and

a control system;

wherein the angular vibration table assembly comprises a base, a hydrostatic bearing, a torque motor, an adapter assembly, an encoder, a conductive slip ring, a thermal-insulating shaft and a worktable;

the base is arranged at a bottom of the angular vibration table assembly;

the torque motor comprises a stator and a rotor; the stator is arranged inside the base, and is fixedly connected to the base; the torque motor is internally provided with a motor shaft; and the rotor is connected to the motor shaft;

the hydrostatic bearing is arranged at an outer periphery of the base;

a top of the motor shaft is fixedly connected to the hydrostatic bearing through the adapter assembly; and a bottom of the motor shaft is provided with the encoder;

the conductive slip ring is arranged on the encoder;

the worktable is arranged inside the temperature-controllable chamber; and a top of the adapter assembly is connected to the worktable through the thermal-insulating shaft; and

the control system is configured to control a temperature of the temperature-controllable chamber, and an angular frequency, an angular rate and an angular position of the angular vibration table assembly.

In some embodiments, the hydrostatic bearing comprises a bearing seat, an upper bearing sleeve, a hydrostatic shaft and a lower bearing sleeve;

the hydrostatic shaft is configured to be hollow; a shaft shoulder is arranged at a middle of an outer periphery of the hydrostatic shaft; the upper bearing sleeve and the lower bearing sleeve are fitted to the outer periphery of the hydrostatic shaft, respectively; a gap is provided between the hydrostatic shaft and the upper bearing sleeve and between the hydrostatic shaft and the lower bearing sleeve; the upper bearing sleeve is arranged above the shaft shoulder; the lower bearing sleeve is arranged below the shaft shoulder; and the upper bearing sleeve and the lower bearing sleeve are fixedly arranged in the bearing seat; and

the bearing seat is provided with an oil inlet; the bearing seat, the upper bearing sleeve and the lower bearing sleeve are each provided with an oil channel; the base is provided with an oil-returning groove and an oil outlet; the oil channel communicates with the oil-returning groove and the oil outlet; the upper bearing sleeve and the lower bearing sleeve are each provided with an oil storage cavity; and a hydrostatic oil film is formed between the hydrostatic shaft and the upper bearing sleeve and between the hydrostatic shaft and the lower bearing sleeve.

In some embodiments, the adapter assembly comprises an adapter flange and a transmission key; and

the top of the motor shaft is provided with a mounting groove; the transmission key is arranged in the mounting groove, and is screwedly fixed to the motor shaft; the adapter flange is screwedly fixed to the top of the motor shaft; a gap is provided between a top surface of the transmission key and a bottom surface of the adapter flange; and the transmission key is in interference fit with both the motor shaft and the adapter flange along a circumferential direction of the motor shaft.

In some embodiments, the thermal-insulating shaft comprises an upper shaft section, a middle shaft section and a lower shaft section;

the upper shaft section and the lower shaft section are made of stainless steel; and the middle shaft section is made of a ceramic material;

the middle shaft section is axially provided with a plurality of through holes for screwed connection of the upper shaft section, the middle shaft section and the lower shaft section; the upper shaft section is screwedly connected to the worktable; and the lower shaft section is screwedly connected to the adapter flange; and

the upper shaft section, the middle shaft section and the lower shaft section are each cylindrical; the lower shaft section is provided with a cable-guiding groove; and a sealing partition is arranged at a center inside the lower shaft section.

In some embodiments, the angular vibration device further comprises:

a water baffle;

a protective cover; and

a felt;

wherein the water baffle is arranged at an outer periphery of the lower shaft section; the protective cover is fixed on an upper end surface of the bearing seat, and arranged at a lower portion of the water baffle; and an upper end surface and a lower end surface of a joint portion between a bottom plate of the temperature-controllable chamber and the thermal-insulating shaft are each provided with the felt.

In some embodiments, the angular vibration device further comprises a plurality of leveling feet fixed at a bottom of the base.

In some embodiments, the angular vibration device further comprises a plurality of reinforcing ribs arranged on the base.

In some embodiments, the temperature of the temperature-controllable chamber ranges from -55ºC to 85ºC; and the angular frequency of the angular vibration table assembly is equal to or greater than 200 Hz.

The present disclosure has the following beneficial effects.

(1) The present disclosure changes the layout of the motor and bearings, and optimizes the traditional bearing arrangement on the motor to the motor arrangement within the bearing, which reduces the overall height of the angular vibration device and increases its stiffness and strength. The angular vibration device can also provide high and low temperature environments, and achieve high-frequency angular vibration in such environments. It is suitable for the calibration of inertial devices under the conditions of high and low temperatures and high-frequency angular vibration, thereby providing key support for the accurate calibration of inertial devices under such conditions, and further improving the performance and environmental adaptability of inertial devices. Thus, the angular vibration device meets the requirements of rapid launch of missile weapons and high-precision navigation.

Moreover, the stator is fixedly connected to the base. The rotor is directly connected to the motor shaft, and there is no transmission clearance between the rotor and the motor shaft, so as to guarantee high accuracy of the system.

(2) Under the action of hydrostatic oil, the hydrostatic bearing forms the hydrostatic oil film between the hydrostatic shaft and the upper bearing sleeve and between the hydrostatic shaft and the lower bearing sleeve. Under the drive of the torque motor, a rotary part of the shaft system is stably rotated. The hydrostatic bearing is configured to support the rotary part of the shaft system. The oil supply and return system is fully performed through the hydrostatic bearing, such that the high-frequency angular vibration can be enabled under larger load conditions.

(3) The present disclosure not only has the water baffle, the protective cover, the felt, and the cable-guiding groove on the lower shaft section, but also features dynamic and static sealing, low-temperature heating and special waterproof wiring structure, thereby effectively preventing condensed water generated in the temperature-controllable chamber during high and low temperature operation from entering the following shaft system.

(4) The base is provided with the plurality of reinforcing ribs to increase the strength and stiffness of the angular vibration device, thereby ensuring the overall stability of the system. Simulation calculation is performed through a finite element software to ensure that the inherent frequency of the system is high enough.

### BRIEF DESCRIPTION OF THE DRAWINGS

FIG. 1 is a three-dimensional schematic diagram of a high-low temperature and high-frequency angular vibration device according to an embodiment of the present disclosure;

FIG. 2 schematically shows a sectional view of a high-frequency angular vibration table assembly according to an embodiment of the present disclosure; and

FIG. 3 is a three-dimensional schematic diagram of a thermal-insulating shaft according to an embodiment of the present disclosure.

In the figures: 1-leveling feet; 2-base; 3-bearing seat; 4-lower bearing sleeve; 5-hydrostatic shaft; 6-upper bearing sleeve; 7-protective cover; 8-lower shaft section; 9-temperature-controllable chamber; 10-middle shaft section; 11-upper shaft section; 12-worktable; 13-adapter flange; 14-transmission key; 15-motor shaft; 16-torque motor; 17-conductive slip ring; 18-encoder; and 19-angular vibration table assembly.

### DETAILED DESCRIPTION OF EMBODIMENTS

The present disclosure will be described detailly in combination with the accompanying figures and the embodiments.

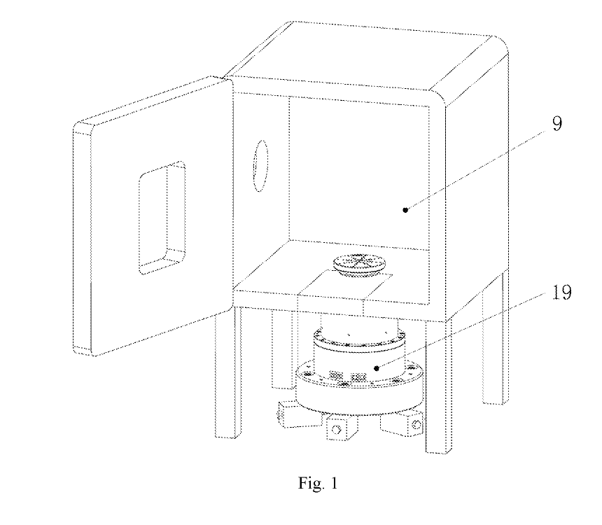

Referring to FIG. 1, this disclosure provides a high-low temperature and high-frequency angular vibration device based on a hydrostatic bearing system. The angular vibration device includes an angular vibration table assembly 19, a temperature-controllable chamber 9 and a control system. The temperature-controllable chamber 9 is configured to provide a specific temperature environment for a to-be-tested sample. The control system is configured to control a temperature of the temperature-controllable chamber 9, and an angular frequency, an angular rate and an angular position of the angular vibration table assembly 19. The control system is configured to enable a calibration function under an integrated environment with a temperature ranging from -55ºC to 85ºC and an angular frequency greater than 200 Hz.

The angular vibration table assembly 19 is a vertical structure, including a base 2, a hydrostatic bearing, a torque motor 16, an adapter assembly, an encoder 18, a conductive slip ring 17, a thermal-insulating shaft and a worktable 12. The worktable 12 of the angular vibration table assembly 19 is completely arranged inside the temperature-controllable chamber 9. Other components of the angular vibration table assembly 19 are arranged outside the temperature-controllable chamber 9.

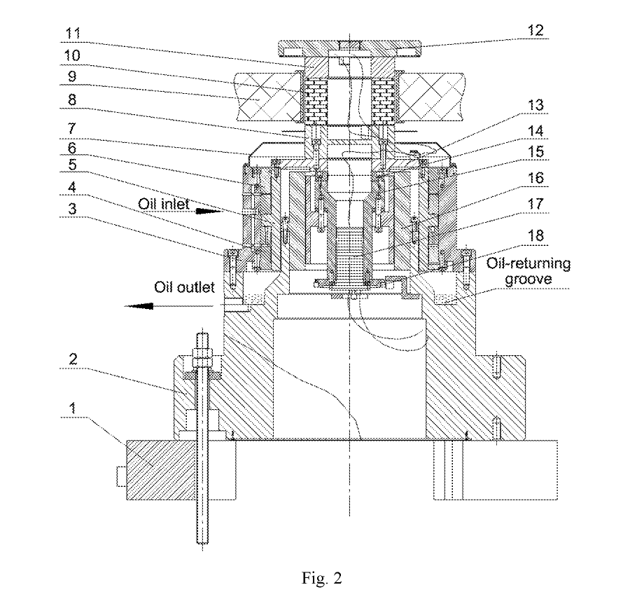

Referring to FIG. 2, the base 2 is arranged at a bottom of the angular vibration table assembly 19, and is provided with a plurality of reinforcing ribs to ensure the stability of overall system. The torque motor 16 includes a stator and a rotor. The stator is arranged inside the base 2, and is fixedly connected to the base 2. The torque motor 16 is internally provided with a motor shaft 15. The rotor is connected to the motor shaft 15. The hydrostatic bearing is arranged at an outer periphery of the base 2. A top of the motor shaft 15 is fixedly connected to the hydrostatic bearing through the adapter assembly. A bottom of the motor shaft 15 is provided with the encoder 18. The conductive slip ring 17 is arranged on the encoder 18. The encoder 18 is configured to feed back an angular position and an angular frequency of a rotary part. The worktable 12 is arranged inside the temperature-controllable chamber 9. A top of the adapter assembly is connected to the worktable 12 through the thermal-insulating shaft.

In some embodiments, the hydrostatic bearing includes a bearing seat 3, an upper bearing sleeve 6, a hydrostatic shaft 5 and a lower bearing sleeve 4.

The hydrostatic shaft 5 is configured to be hollow. A shaft shoulder is arranged at a middle of an outer periphery of the hydrostatic shaft 5. The upper bearing sleeve 6 and the lower bearing sleeve 4 are fitted to the outer periphery of the hydrostatic shaft 5, respectively. A gap is provided between the hydrostatic shaft 5 and the upper bearing sleeve 6 and between the hydrostatic shaft 5 and the lower bearing sleeve 4. The upper bearing sleeve 6 is arranged above the shaft shoulder. The lower bearing sleeve 4 is arranged below the shaft shoulder. The shaft shoulder is configured to fit the upper bearing sleeve 6 and the lower bearing sleeve 4 to form a thrust surface. The upper bearing sleeve 6 and the lower bearing sleeve 4 are fixedly arranged in the bearing seat 3.

The bearing seat 3 is provided with an oil inlet. The bearing seat 3, the upper bearing sleeve 6 and the lower bearing sleeve 4 are each provided with an oil channel. The base 2 is provided with an oil-returning groove and an oil outlet. The oil channel communicates with the oil-returning groove and the oil outlet. The upper bearing sleeve 6 and the lower bearing sleeve 4 are each provided with an oil storage cavity. A hydrostatic oil film is formed between the hydrostatic shaft 5 and the upper bearing sleeve 6 and between the hydrostatic shaft 5 and the lower bearing sleeve 4.

The adapter assembly includes an adapter flange 13 and a transmission key 14. The top of the motor shaft 15 is provided with a mounting groove. The transmission key 14 is arranged in the mounting groove, and is screwedly fixed to the motor shaft 15. The adapter flange 13 is screwedly fixed to the top of the motor shaft 15. A gap is provided between a top surface of the transmission key 14 and a bottom surface of the adapter flange 13. The transmission key 14 is in interference fit with both the motor shaft 15 and the adapter flange 13 along a circumferential direction of the motor shaft.

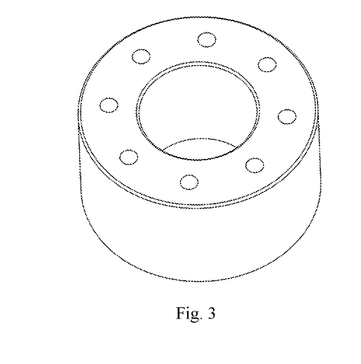

Referring to FIG. 3, the thermal-insulating shaft includes an upper shaft section 11, a middle shaft section 10 and a lower shaft section 8. The middle shaft section 10 is axially provided with a plurality of through holes for screwed connection of the upper shaft section 11, the middle shaft section 10 and the lower shaft section 8. The upper shaft section 11 and the lower shaft section 8 are made of stainless steel, possessing a superior stiffness and facilitating processing. The middle shaft section 10 is made of a ceramic material, possessing a superior thermal-insulated performance. The upper shaft section 11 is screwedly connected to the worktable 12. The lower shaft section 8 is screwedly connected to the adapter flange 13.

The upper shaft section 11, the middle shaft section 10 and the lower shaft section 8 are each cylindrical. The lower shaft section 8 is provided with a cable-guiding groove. A sealing partition is arranged at a center inside the lower shaft section 8, so as to prevent condensate water from flowing downward.

The to-be-tested sample is placed on the worktable 12. Cables of the to-be-tested sample are configured to pass through the upper shaft section 11, the middle shaft section 10, an upper portion of the lower shaft section 8 and the cable-guiding groove on the lower shaft section 8, and to be electrically connected to cables of the conductive slip ring 17 via an aviation plug within a protective cover 7.

In order to prevent condensed water generated in the temperature-controllable chamber 9 during high and low temperature operation from entering the following shaft system, the present disclosure has a sealed waterproof design. Specifically, the device further includes a water baffle, the protective cover 7 and a felt. The water baffle is arranged at an outer periphery of the lower shaft section 8. The protective cover 7 is fixed on an upper end surface of the bearing seat 3, and arranged at a lower portion of the water baffle. An upper end surface and a lower end surface of a joint portion between a bottom plate of the temperature-controllable chamber 9 and the thermal-insulating shaft are each provided with the felt.

In some embodiments, an annular groove is arranged at the outer periphery of the lower shaft section 8. The water baffle is made of a polytetrafluoroethylene material, and engaged with the annular groove of the lower shaft section 8 through deformation property of such a material.

In some embodiments, the device further includes a plurality of leveling feet 1 fixed at a bottom of the base 2, so as to horizontally adjust the angular vibration device.

In some embodiments, the bottom plate of the temperature-controllable chamber 9 is provided with a detachable drawer, facilitating installation of the angular vibration table assembly 19. When the detachable drawer is removed, the angular vibration table assembly 19 is moved into the temperature-controllable chamber 9 from a side thereof. The middle shaft section 10 enter a detaching space on the bottom plate of the temperature-controllable chamber 9. The worktable 12 is arranged on the bottom plate of the temperature-controllable chamber 9, and then the detachable drawer is installed.

The installation of the angular vibration table assembly 19 is performed through the following steps.

(1) The lower bearing sleeve 4 is screwedly arranged on the bearing seat 3. The hydrostatic shaft 5 is arranged on the lower bearing sleeve 4. The upper bearing sleeve 6 is arranged on the bearing seat 3. Thus, the hydrostatic shaft 5, the lower bearing sleeve 4, the upper bearing sleeve 6 and the bearing seat 3 are configured as an assembly, that is, the hydrostatic bearing.

(2) The base 2 is arranged on the plurality of leveling feet 1. The stator is screwedly fixed to the base 2. The hydrostatic bearing is screwedly fixed to the base 2.

(3) The transmission key 14 is screwedly fixed in the mounting groove of the motor shaft 15 along an axial direction of the motor shaft 15. The adapter flange 13 is screwedly fixed to the motor shaft 15 (not shown in FIGS. 1-3). The transmission key 14 is in interference fit with both the motor shaft 15 and the adapter flange 13 along a circumferential direction of the motor shaft. In order to control dimensional tolerances and geometrical errors, the transmission key 14, the adapter flange 13 and the motor shaft 15 are assembled, then processed together, and configured as an assembly, that is, a main shaft.

(4) The rotor is arranged on the main shaft, and fixed together to the upper bearing sleeve 6.

(5) The encoder 18 is arranged on the motor shaft 15. The conductive slip ring 17 is arranged on the encoder 18.

(6) The lower shaft section 8 is arranged above the adapter flange 13. The protective cover 7 is fixed to the bearing seat 3. The middle shaft section 10, the upper shaft section 11 and the worktable 12 are screwedly fixed in sequence. Thus, the angular vibration table assembly 19 is completely assembled.

(7) After the detachable drawer on the temperature-controllable chamber 9 is removed, the angular vibration table assembly 19 is moved to the bottom plate of the temperature-controllable chamber 9. Then the detachable drawer is installed and sealed.

Some preferable embodiments of the present disclosure have been described above, and are not intended to limit this disclosure. Any modifications, equivalent replacements and improvements made by those skilled in the art without departing from the spirit and principle of the disclosure shall fall within the scope of this application.

What is claimed is:

1. A high-low temperature and high-frequency angular vibration device based on a hydrostatic bearing system, comprising:
an angular vibration table assembly;
a temperature-controllable chamber; and
a control system;
wherein the angular vibration table assembly comprises a base, a hydrostatic bearing, a torque motor, an adapter assembly, an encoder, a conductive slip ring, a thermal-insulating shaft and a worktable;
the base is arranged at a bottom of the angular vibration table assembly;
the torque motor comprises a stator and a rotor; the stator is arranged inside the base, and is fixedly connected to the base; the torque motor is internally provided with a motor shaft; and the rotor is connected to the motor shaft;
the hydrostatic bearing is arranged at an outer periphery of the base;
a top of the motor shaft is fixedly connected to the hydrostatic bearing through the adapter assembly; and a bottom of the motor shaft is provided with the encoder;
the conductive slip ring is arranged on the encoder;
the worktable is arranged inside the temperature-controllable chamber; and a top of the adapter assembly is connected to the worktable through the thermal-insulating shaft; and
the control system is configured to control a temperature of the temperature-controllable chamber, and an angular frequency, an angular rate and an angular position of the angular vibration table assembly.

2. The angular vibration device of claim 1, wherein the hydrostatic bearing comprises a bearing seat, an upper bearing sleeve, a hydrostatic shaft and a lower bearing sleeve;
the hydrostatic shaft is configured to be hollow; a shaft shoulder is arranged at a middle of an outer periphery of the hydrostatic shaft; the upper bearing sleeve and the lower bearing sleeve are fitted to the outer periphery of the hydrostatic shaft, respectively; a gap is provided between the hydrostatic shaft and the upper bearing sleeve and between the hydrostatic shaft and the lower bearing sleeve; the upper bearing sleeve is arranged above the shaft shoulder; the lower bearing sleeve is arranged below the shaft shoulder; and the upper bearing sleeve and the lower bearing sleeve are fixedly arranged in the bearing seat; and
the bearing seat is provided with an oil inlet; the bearing seat, the upper bearing sleeve and the lower bearing sleeve are each provided with an oil channel; the base is provided with an oil-returning groove and an oil outlet; the oil channel communicates with the oil-returning groove and the oil outlet; the upper bearing sleeve and the lower bearing sleeve are each provided with an oil storage cavity; and a hydrostatic oil film is formed between the hydrostatic shaft and the upper bearing sleeve and between the hydrostatic shaft and the lower bearing sleeve.

3. The angular vibration device of claim 1, wherein the adapter assembly comprises an adapter flange and a transmission key; and
the top of the motor shaft is provided with a mounting groove; the transmission key is arranged in the mounting groove, and is screwedly fixed to the motor shaft; the adapter flange is screwedly fixed to the top of the motor shaft; a gap is provided between a top surface of the transmission key and a bottom surface of the adapter flange; and the transmission key is in interference fit with both the motor shaft and the adapter flange along a circumferential direction of the motor shaft.

4. The angular vibration device of claim 3, wherein the thermal-insulating shaft comprises an upper shaft section, a middle shaft section and a lower shaft section;
the upper shaft section and the lower shaft section are made of stainless steel; and the middle shaft section is made of a ceramic material;
the middle shaft section is axially provided with a plurality of through holes for screwed connection of the upper shaft section, the middle shaft section and the lower shaft section; the upper shaft section is screwedly connected to the worktable; and the lower shaft section is screwedly connected to the adapter flange; and
the upper shaft section, the middle shaft section and the lower shaft section are each cylindrical; the lower shaft section is provided with a cable-guiding groove; and a sealing partition is arranged at a center inside the lower shaft section.

5. The angular vibration device of claim 4, further comprising:
a water baffle;
a protective cover; and
a felt;
wherein the water baffle is arranged at an outer periphery of the lower shaft section; the protective cover is fixed on an upper end surface of the bearing seat, and arranged at a lower portion of the water baffle; and an upper end surface and a lower end surface of a joint portion between a bottom plate of the temperature-controllable chamber and the thermal-insulating shaft are each provided with the felt.

6. The angular vibration device of claim 1, further comprising:
a plurality of leveling feet fixed at a bottom of the base.

7. The device of claim 1, further comprising:
a plurality of reinforcing ribs arranged on the base.

8. The device of claim 1, wherein the temperature of the temperature-controllable chamber ranges from -55ºC to 85ºC; and the angular frequency of the angular vibration table assembly is equal to or greater than 200 Hz.
